(19) United States
(12) Patent Application Publication
(10) Pub. No.: US 2010/0136282 A1
(43) Pub. Date: Jun. 3, 2010

(54) Flat Panel Television Protective Cover

(76) Inventor: Charles Moss, Gilbert, AZ (US)

Correspondence Address: Charles Moss, 129 South Abalone Dr., Gilbert, AZ, 85233, US

(21) Appl. No.: 12/343,138

(22) Filed: Dec. 23, 2008

Related U.S. Application Data
(60) Provisional application No. 61/119,080, filed on Dec. 2, 2008.

(51) Int. Cl. B32B 3/06

(52) U.S. Cl. 428/99

(57) ABSTRACT

The invention objective is to protect Flat Panel televisions from dust, wind, fingerprints, and moisture when not in use. This is for televisions that are placed in open areas susceptible to element exposure such as on an enclosed or covered patios, sunrooms, hallways, and decks. The invention is constructed of a light-weight material that is soft on the inside with a water resistant shell. The cover is form fitted and uses a cord and grommet system to tightly secure cover around the TV.

### PRIORITY

The present invention claims priority based upon the provisional application 61/119,080 which was filed on Dec. 2, 2008.

### FIELD OF THE INVENTION

The present invention relates to televisions and more particularly to a protective cover for a television.

### BACKGROUND OF THE INVENTION

Televisions are susceptible to dust and damage from food and other items which may be found around the average home. With televisions becoming very expensive, there is not an adequate way to protect these televisions from damage.

### SUMMARY

A cover may incjude a fabric; and a tightening system; wherein the fabric wraps around a television and is secured by the tightening system.

### BRIEF DESCRIPTION OF THE DRAWINGS

The invention may be understood by reference to the following description taken in conjunction with the accompanying drawings, in which, like reference numerals identify like elements, and in which:

FIG. 1 is a front perspective view of the invention 10 in use;

FIG. 2 is a rear perspective view of the invention 10 in use;

FIG. 3 is a partial perspective view of an alternate embodiment of the invention 10 using Velcro 34 closures;

FIG. 4 is a rear perspective view of another embodiment of the invention 10 using a cord 14 closure channeled directly through the fabric 20;

FIG. 5 is a rear perspective view of still another embodiment of the invention 10 using an elastic band 32 channeled directly through the fabric 20 being easily removed;

FIG. 6 is a partial rear perspective view of another embodiment of the invention 10 using adjustable straps 36 and plastic buckles 38

### DETAILED DESCRIPTION

### DESCRIPTION LIST

10: is the overall invention.

12: are grommets (number as needed) of plastic or metal in any desired size.

12a: is the center bottom grommet. 14: is a cord of needed length.

16: is a cord of any king/material.

18: are cord ends of any kind.

20: is any light-weight fabric material that is soft on the inside and water resistant polyvinyl (or other material) outer shell.

22: is a fabric 20 piece cut to size to fit the main screen area of the flat panel TV 30.

24: are two fabric 20 pieces cut to size to fit the sides (height) of the flat panel TV 30.

26: are two fabric 20 pieces cut to size to fit the top and bottom (width) of the flat panel TV 30.

28: is stitching.

30: is a flat panel TV of any size.

32: is an elastic band, cord or bungee.

34: are male and female Velcro strips.

36: are adjustable straps.

38: is a plastic buckle.

The present invention includes a protective cover for Flat Screen, LCD TFT, Plasma, or Flat Panel televisions. The cover is adjustable to tightly fit around the different variations of TV enclosures.

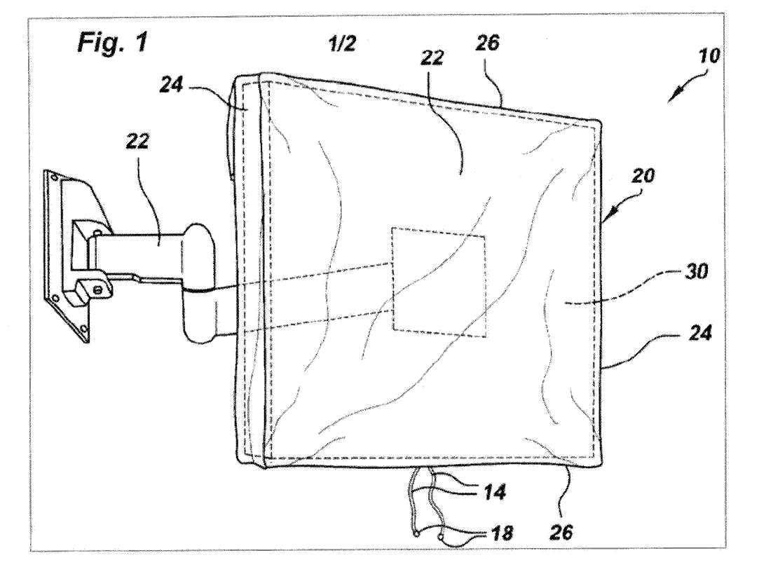

The invention includes the following elements (a) Fabric and (b) tightening system. These elements are connected as follows: the fabric (FIG. 1 item 20) is cut or shaped to a pattern that forms around the front, top, bottom, sides, and back of any television molding(FIG. 1. item 30). The cut pieces are sewn together. The tightening system is attached to the fabric. It should be noted that: (a) the fabric(FIG. 1. item 20) could be made of various materials, such as but not limited to Poly vinyl, leather, nylon, tapestry, fleece, wool, poly (tetrafluoroethene), polychloroprene, elastane, cotton, canvas, but Poly vinyl is preferable; and (b) the tightening system could be made of various materials, such as but not limited to Poly vinyl, leather, nylon, grommets of any type, tapestry, fleece, wool, poly (tetrafluoroethene), polychloroprene, elastane, cotton, rope of any type, plastic, canvas, grommets of any type, velcro, but nylon is preferable. The tightening system can be attached to the fabric by various devices, such as but not limited to thread, string, zippers of any type, buckles of any type, snaps of any type, rivets of any type, screws of any type, nuts and bolts, adhesives of any type, rope of any type, cord of any type, or tape of any type, but thread and grommets are preferable. Further, this invention can have one or more of the following: (c) a handle, which is attached to the top of the cover; and (d) a pocket, sewn onto the front, top, bottom, and/or sides

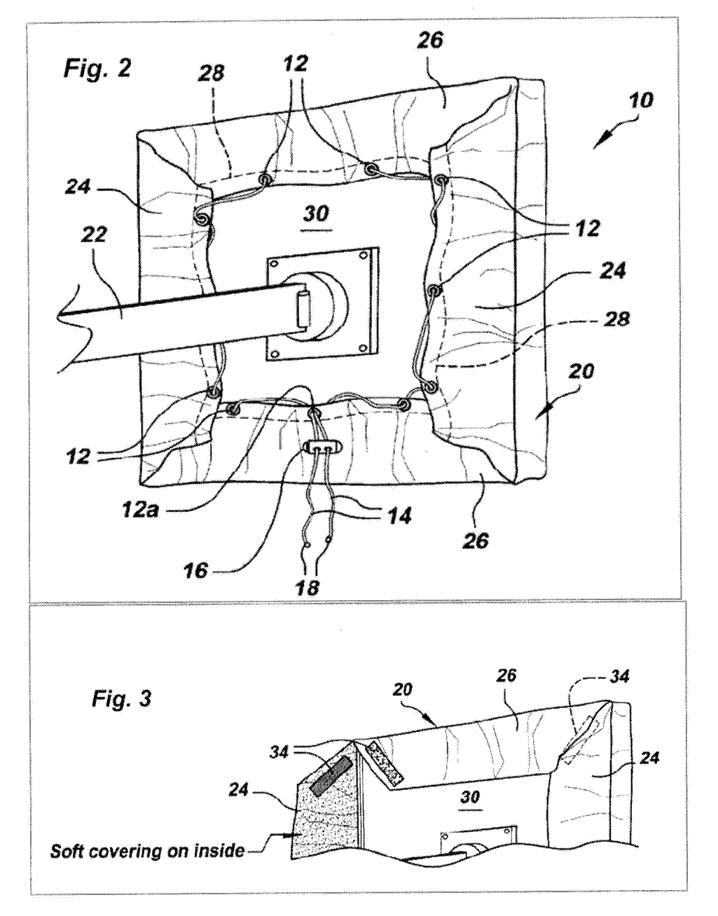

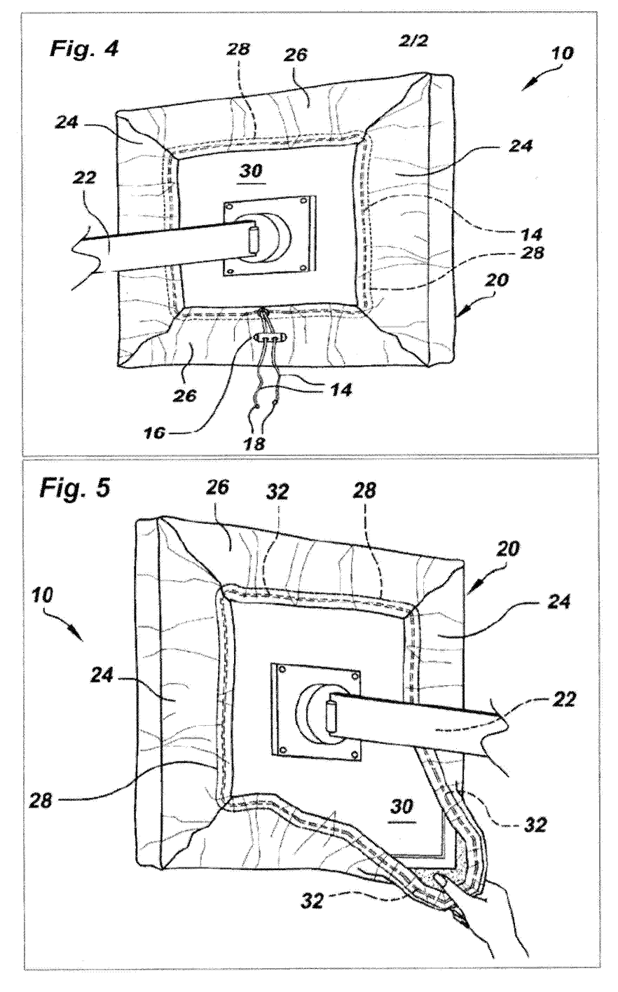

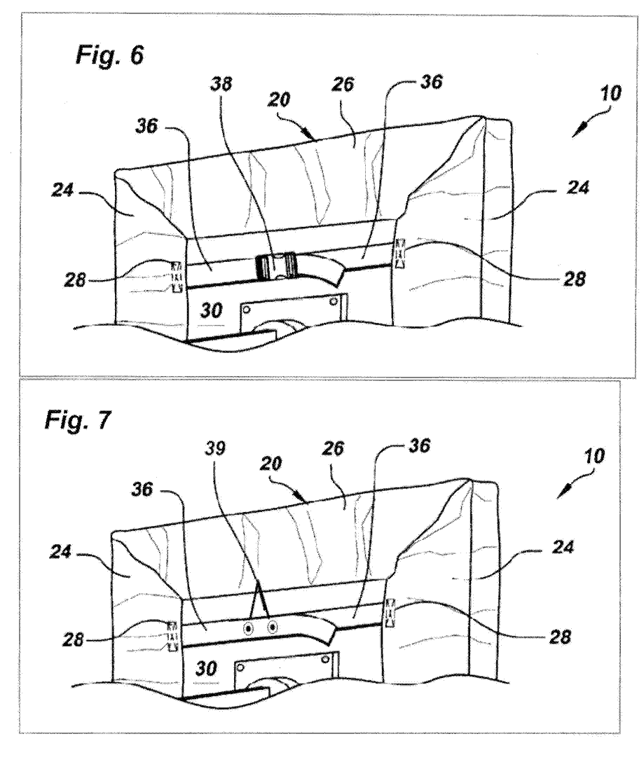

The invention includes the fabric (FIG. 1 item 20), the fabric is cut or shaped to meet dimensions of a TV molding. The pattern cuts or shapes are connected together to form around the television molding (FIG. 1 item 30). The tightening system is installed to join all the pattern cuts or shapes (FIG. 1 items 22,24,26) on the back of the invention. The completed cover is then reviewed for quality and all fabric and thread remnants are removed. The cover is opened up and placed around the TV component (FIG. 1 item 30). Once around the TV, the tightening system is engaged bringing the top, sides, and bottom pieces together. This action will tighten the cover around the TV and adjusts to accommodate the variations in TV enclosure sizes. The tightening is secured when the desired tightness is achieved. The invention can use but not limited to a cord or cords (FIG. 2 item 14) attached to the fabric with a cord stop (FIG. 2 item 16) to secure the tightness around the television component. In addition, other methods could be used to secure the tightness around the television enclosure system; material (b) of any type can be tied; Velcro could be attached to the fabric by various means (FIG. 3); material (b) of any type could be channeled directly through fabric (FIG. 4); An elastic band or ‘bungee’ cord could be attached to the fabric by various means (FIG. 5);Snaps of any type could be attached to the fabric by various devices; Zippers of any type could be attached to the fabric by various means; adhesive of any type can be attached to the fabric by various devices; Plastic buckling of any type could be attached to the fabric by various devices (FIG. 6); but a cord with a cord lock is preferred

The invention can also be used for indoor installations. It can also cover computer monitors and some pedestal mounted TV's. The pedestal would need to connect to the back of the component and not on the bottom.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

What is claimed is:

1. A cover comprising of a fabric; and a tightening system; wherein the fabric wraps around a television and is secured by the tightening system.

2. A cover of claim 1 further comprises a cord that connected to the fabric to facilitate tightening around a television.

3. A cover of claim 2 wherein the cord is made of at least one of nylon, polyester, hemp, cotton, polyvinyl and/or leather.

4. A cover of claim 3 wherein the cord is connected to the fabric through grommets.

5. A cover of claim 4 wherein the cord is secured with a cord lock.
